(19) United States
(12) Patent Application Publication
(10) Pub. No.: US 2012/0122348 A1
(43) Pub. Date: May 17, 2012

(54) CONNECTOR AND INTERFACE DEVICE

(75) Inventors: Bong-hwan CHO, Suwon-si (KR); Seung-kwon PARK, Yongin-si (KR); Il-ju NA, Yongin-si (KR); Jae-min LEE, Suwon-si (KR); Sang-soo LEE, Seoul (KR); Joon-hyun BAEK, Seongnam-si (KR)

(73) Assignee: SAMSUNG ELECTRONICS CO., LTD., Suwon-si (KR)

(21) Appl. No.: 13/294,826

(22) Filed: Nov. 11, 2011

Related U.S. Application Data
(60) Provisional application No. 61/412,909, filed on Nov. 12, 2010.

(30) Foreign Application Priority Data
Feb. 25, 2011 (KR) 10-2011-0017246

(51) Int. Cl. H01R 24/00

(52) U.S. Cl. 439/660

(57) ABSTRACT

A connector and an interface device are provided. The connector includes: a plurality of contact locations having sequentially designated numbers; and a housing which houses the plurality of contact locations. The plurality of contact locations include: a first device pair contact location group which is configured to transmit data between a first pair of devices; a second device pair contact location group which is configured to transmit data between a second pair of devices; a third device pair contact location group which is configured to transmit data between a third pair of devices; and a fourth device pair contact location group which is configured to transmit data between a fourth pair of devices.

### CROSS-REFERENCE TO RELATED APPLICATION

This application claims priority from U.S. Provisional Patent Application No. 61/412,909, filed on Nov. 12, 2010 in the U.S. Patent and Trademark Office and Korean Patent Application No. 10-2011-0017246, filed on Feb. 25, 2011 in the Korean Intellectual Property Office, the disclosures of which are incorporated herein by reference in their entirety.

### BACKGROUND

1. Field

Apparatuses and methods consistent with exemplary embodiments relate to a connector and an interface device, and more particularly, to a connector which enables a high-speed signal transmission and connects a plurality of media player devices, and an interface device.

2. Description of the Related Art

A cable connector is a device which transmits an electric signal between two electronic devices. Examples of cable connectors includes a High-Definition Multimedia Interface (HDMI) cable connector, a Universal Serial Bus (USB) cable connector, an audio cable connector, a video cable connector, etc.

Recent electronic devices can be connected to various types of external devices, and thus include various standards of connectors to be connected to the various types of external devices. For example, a recent television (TV) can be connected to a digital versatile disk (DVD) player, a set-top box, a speaker, a computer, or the like and thus includes an HDMI cable connector, a USB cable connector, an audio cable connector, a video cable connector, etc., as described above.

However, using different types of connectors for different devices is not efficient in terms of compatibility between electronic devices. Therefore, a connector capable of easily transmitting images, sound, and control signals to a plurality of electronic devices is desirable.

### SUMMARY

One exemplary embodiments may overcome the above disadvantages and other disadvantages not described above. However, it is understood that one exemplary embodiment are not required to overcome the disadvantages described above, and may not overcome any of the problems described above.

According to an aspect of an exemplary embodiment, there is provided a connector which connects to media player devices, the connector including: a plurality of contact locations having sequentially designated numbers; and a housing which houses the plurality of contact locations, wherein the plurality of contact locations includes: a first device pair contact location group which is configured to transmit transmits first data between a first pair of devices; a second device pair contact location group which is configured to transmit second data between a second pair of devices; a third device pair contact location group which is configured to transmit third data between a third pair of devices; and a fourth device pair contact location group which is configured to transmit fourth data between a fourth pair of devices.

The first device pair contact location group may include a first device pair plus contact location and a first device pair minus contact location for differential signaling, and a first device pair ground contact location.

The connector may be compatible with a High-Definition Multimedia Interface connector.

The connector may be a 19-pin connector.

At least one of the plurality of contact locations may include a power transmission contact location which transmits power.

The plurality of contact locations may further include a Consumer Electronics Control (CEC) contact location.

The connector may be compatible with a High-Definition Multimedia Interface connector, and the first device pair contact location group corresponds to a Transition Minimized Differential Signaling contact location.

The first device pair contact location group may be designated as numbers from 10 to 12; the second device pair contact location group may be designated as numbers from 7 to 9; the third device pair contact location group may be designated as numbers from 4 to 6; and the fourth device pair contact location group may be designated as numbers from 1 to 3.

The plurality of contact locations may further include a fifth device pair contact location group which is configured to transmit data between a fifth pair of devices.

The connector may be compatible with a High-Definition Multimedia Interface (HDMI) connector, and the fifth device pair contact location group corresponds to an Ethernet and Audio Return Channel of the HDMI connector.

The fifth device pair contact location group may be ground-processed via at least one of a ground contact location and a drain wire of another contact location group.

The fifth device pair contact location group may be designated as numbers 14, 17, and 19.

The plurality of contact locations may further include a sixth device pair contact location group which is configured to transmit data between a sixth pair of devices.

The connector may be compatible with a High-Definition Multimedia Interface (HDMI) connector, and the sixth device pair contact location group corresponds to a serial data contact location and a serial clock contact location of the HDMI connector.

The sixth device pair contact location group may be ground-processed via at least one of a ground contact location and a drain wire of another contact location group.

The sixth device pair contact location group may be designated as numbers 15 and 16.

According to an aspect of an exemplary embodiment there is provided a connector which connects to media player devices, wherein the connector includes: a plurality of contact locations having sequentially designated numbers; and a housing which houses the plurality of contact locations, wherein the plurality of contact locations includes: a first device pair contact location group which is configured to transmit data between a first pair of devices; a second device pair contact location group which is configured to transmit data between a second pair of devices; a third device pair contact location group which is configured to transmit data between a third pair of devices; a fourth device pair contact location group which is configured to transmit data between a fourth pair of devices; a fifth device pair contact location group which is configured to transmit data between a fifth pair of devices; a sixth device pair contact location group which is configured to transmit data between a sixth pair of devices; a seventh device pair contact location group which is configured to transmit data between a seventh pair of devices; and an eighth device pair contact location group which is configured to transmit data between an eighth pair of devices.

The first device pair contact location group may include a first device pair plus contact location and a first device pair minus contact location for differential signaling.

The connector is compatible with a High-Definition Multimedia Interface connector.

The connector is a 19-pin connector.

The plurality of contact locations may further include a power transmission contact location which transmits power.

At least one of the plurality of contact locations comprises a Consumer Electronics Control contact location.

The connector as claimed in claim 17, wherein the connector is compatible with a High-Definition Multimedia Interface (HDMI) connector, and the first device pair contact location group corresponds to a Transition Minimized Differential Signaling contact location of the HDMI connector.

The first device pair contact location group may be designated as numbers 10 and 12; the second device pair contact location group may be designated as numbers 7 and 9; the third device pair contact location group may be designated as numbers 4 and 6; the fourth device pair contact location group may be designated as numbers 1 and 3; the fifth device pair contact location group may be designated as numbers 2 and 5; the sixth device pair contact location group may be designated as numbers 8 and 11; the seventh device pair contact location group may be designated as numbers 15 and 16; and the eighth device pair contact location group may be designated as numbers 14 and 19.

At least one of the plurality of contact locations may include a contact location for ground processing, which may be designated as number 17, wherein the eighth device pair contact location group uses the contact location, which is designated as the number 17, as a ground contact location.

At least one of the plurality of device pair contact location groups may be ground-processed via at least one of a ground contact location and a drain wire of another device pair contact location group.

The connector may be compatible with a High-Definition Multimedia Interface (HDMI) connector, and the eighth device pair contact location group corresponds to a Ethernet and Audio Return Channel contact location of the HDMI connector.

The connector may be compatible with a High-Definition HDMI connector, and the seventh device pair contact location group corresponds to a serial data contact location and a serial clock contact location of the HDMI connector.

According to an aspect of an exemplary embodiment, there is provided an interface device which interfaces media player devices, the interface device including: a plurality of contact locations having numbers which are sequentially designated; and a housing unit which comprises the plurality of contact locations, wherein the plurality of contact locations includes: a first device pair contact location group which is configured to transmit data between a first pair of devices; a second device pair contact location group which is configured to transmit data between a second pair of devices; a third device pair contact location group which is configured to transmit data between a third pair of devices; and a fourth device pair contact location group which is configured to transmit data between a fourth pair of devices.

The interface device as claimed in claim 29, wherein the first device pair contact location group comprises a first device pair plus contact location and a first device pair minus contact location for differential signaling, and a first device pair ground contact location.

The housing unit may be compatible with a High-Definition Multimedia Interface (HDMI) housing unit.

The housing unit may be a 19-pin housing unit.

At least one of the plurality of contact locations may include a power transmission contact location.

At least one of the plurality of contact locations may include a Consumer Electronics Control (CEC) contact location.

The housing unit may be compatible with a HDMI housing unit, and the first device pair contact location group corresponds to a TMDS contact location.

The first device pair contact location group may be designated as numbers from 10 to 12; the second device pair contact location group may be designated as numbers from 7 to 9; the third device pair contact location group may be designated as numbers from 4 to 6; and the fourth device pair contact location group may be designated as numbers from 1 to 3.

The plurality of contact locations may further include a fifth device pair contact location group which is configured to transmit data between a fifth pair of devices.

The housing unit may be compatible with a High-Definition Multimedia Interface (HDMI) housing unit, and the fifth device pair contact location group corresponds to a Ethernet and Audio Return Channel (HEAC) contact location.

The fifth device pair contact location group may be ground-processed via at least one of a ground contact location and a drain wire of another contact location group.

The fifth device pair contact location group may be designated as numbers 14, 17, and 19.

The plurality of contact locations may further include a sixth device pair contact location group which is configured to transmit data between a sixth pair of devices.

The housing unit may be compatible with a HDMI housing unit, and the sixth device pair contact location group corresponds to a serial data (SDA) contact location and a serial clock (SCL) contact location.

The sixth device pair contact location group may be ground-processed via at least one of a ground contact location and a drain wire of another contact location group.

The sixth device pair contact location group may be designated as numbers 15 and 16.

The interface device may transmit and receive a wakeup signal, wherein the wakeup signal wakes up a media player device from a standby mode.

At least one of the plurality of contact locations may include a Consumer Electronics Control contact location, wherein the CEC contact location transmits and receives the wakeup signal with the media player device.

The wakeup signal may include a start field which acknowledges a start of a wakeup command, a wakeup mode field which acknowledges a wakeup mode, and an Ack signal field.

The mode of the wakeup may include a plurality of wakeup modes, which respectively correspond to a plurality of operation modes of a media player device, and a charging mode.

If the interface device receives a wakeup start command from a microcomputer, the interface device may determine an external media player device, based on the wakeup start command.

The wakeup start command may include a start field which acknowledges a start of a wakeup command, a wakeup port filed which is to acknowledge a device to be woken up, a wakeup mode field which acknowledges a wakeup mode, and an Ack signal field.

The interface device may transmit and receive power with an external media player device via at least two contact locations of the plurality of contact locations.

At least one of the at least two contact locations, which transmit and receive the power, may be an audio/video (A/V) data transmission contact location.

The first device pair contact location group is designated as numbers 10 and 12; the second device pair contact location group is designated as numbers 7 and 9; the third device pair contact location group is designated as numbers 4 and 6; and, the fourth device pair contact location group is designated as numbers 1 and 3.

According to an aspect of an exemplary embodiment, there is provided an interface device which interfaces a media player devices, the interface device including: a plurality of contact locations having sequentially designated numbers; and a housing unit which comprises the plurality of contact locations, wherein the plurality of contact locations comprise: a first device pair contact location group which is configured to transmit data between a first pair of devices; a second device pair contact location group which is configured to transmit data between a second pair of devices; a third device pair contact location group which is configured to transmit data between a third pair of devices; a fourth device pair contact location group which is configured to transmit data between a fourth pair of devices; a fifth device pair contact location group which is configured to transmit data between a fifth pair of devices; a sixth device pair contact location group which is configured to transmit data between a sixth pair of devices; a seventh device pair contact location group which is configured to transmit data between a seventh pair of devices; and an eighth device pair contact location group which is configured to transmit data between an eighth pair of devices.

The first device pair contact location group may include a first device pair plus contact location and a first device pair minus contact location for differential signaling.

The housing unit may be compatible with a HDMI housing unit.

The housing unit is a 19-pin housing unit.

The plurality of contact locations may further include a power transmission contact location which transmits power.

At least one of the plurality of contact locations may include a Consumer Electronics Control (CEC) contact location.

The housing unit may be compatible with a High-Definition Multimedia Interface (HDMI) housing unit, and the first device pair contact location group corresponds to a Transition Minimized Differential Signaling (TMDS) contact location.

The first device pair contact location group may be designated as numbers 10 and 12; the second device pair contact location group is designated as numbers 7 and 9; the third device pair contact location group is designated as numbers 4 and 6; the fourth device pair contact location group is designated as numbers 1 and 3; the fifth device pair contact location group is designated as numbers 2 and 5; the sixth device pair contact location group is designated as numbers 8 and 11; the seventh device pair contact location group is designated as numbers 15 and 16; and the eighth device pair contact location group is designated as numbers 14 and 19.

The plurality of contact locations may further include a contact location which is for ground processing and is designated as number 17, wherein the eighth device pair contact location group uses the contact location, which is designated as the number 17, as a ground contact location.

At least one of the plurality of device pair contact location groups may be ground-processed via at least one of a ground contact location and a drain wire of another device pair contact location group.

The housing unit may be compatible with a High-Definition Multimedia Interface (HDMI) housing unit, and the eighth device pair contact location group corresponds to a Ethernet and Audio Return Channel (HEAC) contact location.

The housing unit may be compatible with a High-Definition Multimedia Interface (HDMI) housing unit, and the seventh device pair contact location group corresponds to a serial data (SDA) contact location and a serial clock (SCL) contact location.

The interface device may transmit and receive a wakeup signal, wherein the wakeup signal wakes up the external media player device from a standby mode.

At least one of the plurality of contact locations may include a Consumer Electronics Control (CEC) contact location, wherein the CEC contact location transmits and receives the wakeup signal with the media player device.

The wakeup signal may include a start field which acknowledges a start of a wakeup command, a wakeup mode field which acknowledges a wakeup mode, and an Ack signal field.

The mode of the wakeup may include a plurality of wakeup modes, which respectively correspond to a plurality of operation modes of a media player device, and a charging mode.

If the interface device receives a wakeup start command, the interface device may determine an external media player device based on the wakeup start command.

The wakeup start command may include a start field which acknowledges a start of a wakeup command, a wakeup port filed which acknowledges a device to be woken up, a wakeup mode field which acknowledges a wakeup mode, and an Ack signal field.

The interface device may transmit and receive power with an external media player device via at least two contact locations of the plurality of contact locations.

At least one of the at least two contact locations, which transmit and receive the power, may be an A/V data transmission contact location.

The first device pair contact location group may be designated as numbers 1 and 3; the second device pair contact location group may be designated as numbers 2 and 4; the third device pair contact location group may be designated as numbers 5 and 7; the fourth device pair contact location group may be designated as numbers 6 and 8; the fifth device pair contact location group may be designated as numbers 9 and 11; the sixth device pair contact location group may be designated as numbers 10 and 12; the seventh device pair contact location group may be designated as numbers 13 and 15; and the eighth device pair contact location group may be designated as numbers 14 and 16.

The plurality of contact locations may further include: a Consumer Electronics Control (CEC) contact location; a ground contact location for ground processing; and a power contact location which transmits power.

The CEC contact location may be designated as number 13; the ground contact location may be designated as number 17; and the power contact location may be designated as number 18.

The plurality of contact locations may further include: a CEC contact location which is designated as number 19; a ground contact location which is for ground processing and is designated as number 17; and a power contact location which transmits power and is designated as number 18.

### BRIEF DESCRIPTION OF THE DRAWINGS

The above and/or other aspects will be more apparent by describing in detail exemplary embodiments, with reference to the accompanying drawings, in which:

FIG. 1 is a block illustrating a structure of a media player device according to an exemplary embodiment;

FIG. 2 is a block diagram illustrating a structure of an interface device according to an exemplary embodiment:

FIG. 3 is a view illustrating a detailed shape of a housing, an example of which is shown in FIG. 2, according to an exemplary embodiment;

FIG. 4 is a view illustrating a structure of a connector cable according to an exemplary embodiment;

FIG. 5 is a view illustrating a detailed shape of a connector, an example of which is shown in FIG. 4, according to an exemplary embodiment;

FIG. 6 is a view illustrating an interface structure according to an exemplary embodiment;

FIG. 7 is a view illustrating a high definition multimedia interface (HDMI) structure according to an exemplary embodiment;

FIG. 8 is a view illustrating the interface structure, an example of which is shown in FIG. 6 which is represented on a connector;

FIG. 9 is a cross-sectional view illustrating a cable using the interface structure, an example of which is shown in FIG. 6;

FIG. 10 is a view illustrating an interface structure according to another exemplary embodiment;

FIG. 11 is a view illustrating the interface structure, an example of which is shown in FIG. 10 which is represented on a connector;

FIG. 12 is a view illustrating a cross-sectional view illustrating a cable using the interface structure, an example of which is shown in FIG. 10;

FIG. 13 is a view illustrating an interface structure according to another exemplary embodiment;

FIG. 14 is a view illustrating a structure of a connector according to another exemplary embodiment;

FIG. 15 is a cross-sectional view illustrating a cable using the interface structure, an example of which is shown in FIG. 14;

FIG. 16 is a view illustrating an interface structure according to another exemplary embodiment;

FIGS. 17 and 18 are views illustrating a structure of a connector according to another exemplary embodiment;

FIG. 19 is a cross-sectional view illustrating a cable using the interface structure, an example of which is shown in FIG. 16;

FIG. 20 is a view illustrating an interface structure according to another exemplary embodiment;

FIG. 21 is a cross-sectional view illustrating a cable using the interface structure, an example of which is shown in FIG. 20;

FIG. 22 is a view illustrating a method of charging and waking up an external device which is connected to an interface device through an interface as in the above exemplary embodiments, according to an exemplary embodiment;

FIG. 23 is a view illustrating a structure of a wakeup signal according to an exemplary embodiment;

FIG. 24 is a view illustrating a structure of a wakeup start command according to an exemplary embodiment;

FIG. 25 is a view illustrating roles of signals of a wakeup start command according to an exemplary embodiment;

FIG. 26 is a view illustrating types of wakeup mode, an example of which is shown in FIG. 25; and

FIG. 27 is a view illustrating a method of charging and waking up an external device which is connected to the interface device through an interface as in the above exemplary embodiment, according to another exemplary embodiment.

### DETAILED DESCRIPTION OF THE EXEMPLARY EMBODIMENTS

Hereinafter, exemplary embodiments will be described in greater detail with reference to the accompanying drawings.

In the following description, same reference numerals are used for the same elements when they are depicted in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, functions or elements known in the related art are not described in detail since they would obscure the exemplary embodiments with unnecessary detail.

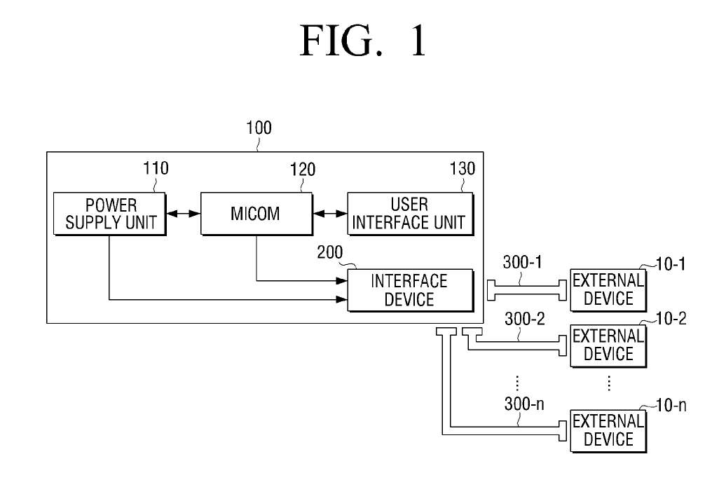

FIG. 1 is a block diagram illustrating a structure of a media player device 100 according to an exemplary embodiment.

Referring to FIG. 1, the media player device 100 includes a power supply unit 110, a microcomputer 120 (MICOM), a user interface unit 130, and an interface device 200.

The media player device 100 is connected to external media player devices (hereinafter referred to as “external devices”) 10-1, 10-2, . . . , and 10-n through cable connectors 300-1, 300-2, . . . , and 300-n. Examples of the media player device 100 include a broadcasting receiving device, such as a digital television (DTV), a digital versatile disk (DVD) player, or a set-top box, a personal computer storing various types of contents, a notebook computer, an MPEG Audio Layer-3 (MP3) player, a portable multimedia player (PMP), a mobile phone, etc.

The power supply unit 110 supplies power to elements of the media player device 100, respectively. The power supply unit 110 may be realized using a switched-mode power supply (SMPS) unit, an electric transformer, or a rectifier circuit.

The power supply unit 110 may also output different types of power according to an operation state of the media player device 100. For example, if the media player device 100 is in a normal mode, the power supply unit 110 may output a normal mode power which is to supply power to all elements of the media player device 100. If the media player device 100 is in a standby mode, the power supply unit 110 may output standby mode power which is to supply power to some of the elements of the media player device 100 which are to stand by. If the media player device 100 operates in a charge mode only for charging the external devices 10-1, 10-2, . . . , and 10-n, the power supply unit 110 may output charge mode power which is to supply power only to the interface device 200 which is used to charges the some elements, which are to stand by, and the external devices 10-1, 10-2, . . . , and 10-n.

The microcomputer 120 controls the elements of the media player device 100. In more detail, the microcomputer 120 may control the elements of the media player device 100 according to an operation mode of the media player device 100 so that an operation corresponding to the operation mode is performed. The media player device 100 may operate in an off mode, a standby mode, a plurality of wakeup modes, a normal mode, or the like.

If the microcomputer 120 receives a control of a user or a wakeup signal of the media player device 100 from the interface device 200, the microcomputer 120 may control the power supply unit 110 to output power corresponding to this.

The microcomputer 120 may generate a wakeup start command to perform a wakeup with respect to the external devices 10-1, 10-2, . . . , and 10-n. In more detail, the microcomputer 120 may generate a wakeup start command to wake up the external device 10-1 according to a control command of the user or internal rules and transmit the wakeup start command to the interface device 200. For example, if the media player device 100 is a DVD player, and the user commands a DVD to be played with a remote controller, the microcomputer 120 may generate a wakeup start command with respect to the external device 10-1, which is a DTV, so as to wake up the external device 10-1 and transmit the wakeup signal to the interface device 200. Here, a detailed structure of the generated wakeup start command will be described later with reference to FIGS. 24 through 26. If the external device 10-1 which is chargeable is connected to the interface device 200, the microcomputer 120 may control the power supply unit 110 to supply power to the external device 10-1. In more detail, if the external device 10-1, which is connected to the media player device 100 through the interface device 200, is recognized as a chargeable device, the microcomputer 120 may control the power supply unit 110 to supply charge mode power or normal mode power to the external device 10-1 through the interface device 200. Here, if charging of the external device 10-1 is completed or the external device 10-1 is disconnected from the media player device 100, the microcomputer 120 may interrupt power supplied to the external device 10-1.

The user interface unit 130 includes a plurality of functional keys which are used by the user to set or select various types of functions supported by the media player device 100. The user interface unit 130 may be realized as a device, in which an input and an output are simultaneously realized, such as a touch pad or the like. The user interface unit 130 may also be realized as a combination of an input unit, such as a keyboard, a mouse, or a wireless remote controller, and an output unit, such as a liquid crystal display (LCD), a cathode-ray tube (CRT), or a speaker.

The user interface unit 130 may output contents of the media player device 100 or contents of the external devices 10-1, 10-2, . . . , and 10-n which are transmitted through the interface device 200.

If the connected external device 10-1 is being charged, the user interface unit 130 may display a charge state of the external device 10-1.

The interface device 200 connects the media player device 100 to the external devices 10-1, 10-2, . . . , and 10-n. In more detail, the interface device 200 may be connected to the plurality of external devices 10-1, 10-2, . . . , and 10-n through the plurality of cable connectors 300-1, 300-2, . . . , and 300-n and transmit an audio/video (A/V) signal to the external devices 10-1, 10-2, . . . , and 10-n which are connected thereto. The interface device 200 may also transmit a wakeup signal to wake up the external devices 10-1, 10-2, . . . , and 10-n or may supply charge power for charging the external devices 10-1, 10-2, . . . , and 10-n.

As described with reference to FIG. 1, the interface device 200 is connected to the external device 10-1 through the cable connector 300-1. However, if a cable connector of 1:n is installed, the interface device 200 may be connected to a plurality of external devices through one cable connector.

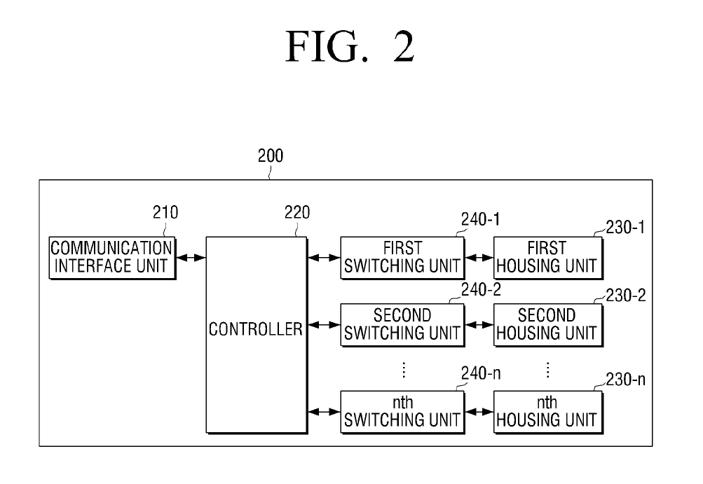

A detailed structure of the interface device 200 will now be described with reference to FIG. 2.

FIG. 2 is a view illustrating the detailed structure of the interface device 200 according to an exemplary embodiment.

Referring to FIG. 2, the interface device 200 includes a communication interface unit 210 a controller 220, a plurality of housing units 230-1, 230-2, . . . , and 230-n, and a plurality of switching units 240-1, 240-2, . . . , and 240-n.

The communication interface unit 210 is connected to the elements of the media player device 100, transmits and receives an A/V signal and a control signal with the elements of the media player device 100, and receives power from the power supply unit 110.

The controller 220 controls elements of the interface device 200. In more detail, the controller 220 may sense whether the external devices 10-1, 10-2, . . . , and 10-n have been respectively connected to the plurality of housing units 230-1, 230-2, . . . , and 230-n. If it is sensed that the external devices 10-1, 10-2, . . . , and 10-n have been respectively connected to the plurality of housing units 230-1, 230-2, . . . , and 230-n, the controller 220 informs the microcomputer 120 that the external devices 10-1, 10-2, . . . , and 10-n have been respectively connected to the plurality of housing units 230-1, 230-2, . . . , and 230-n.

If a wakeup signal is received from the connected external devices 10-1, 10-2, . . . , and 10-n, the controller 220 may transmit the wakeup signal to the microcomputer 120. The controller 220 may combine the wakeup signal with port information corresponding to the external devices 10-1, 10-2, . . . , and 10-2, which have transmitted the wakeup signal, to generate a wakeup start command and may transmit the wakeup start command to the microcomputer 120.

The controller 220 may determine whether the connected external devices 10-1, 10-2, . . . , and 10-n are chargeable devices. If the external devices 10-1, 10-2, . . . , and 10-n are the chargeable devices, the controller 220 may transmit information regarding this to the microcomputer 120 so as to charge the external devices 10-1, 10-2, . . . , and 10-n. Here, if the media player device 100 is in the standby mode, the controller 220 may transmit the wakeup signal to the microcomputer 120.

If charging of the external devices 10-1, 10-2, . . . , and 10-n are completed or the interface device 200 is disconnected from the external devices 10-1, 10-2, . . . , and 10-n, the controller 220 may transmit information regarding this to the microcomputer 120 so as to complete charging of the external devices 10-1, 10-2, . . . , and 10-n.

If the controller 220 receives a wakeup start command with respect to the particular external device 10-2 from the microcomputer 120 or the external device 10-1, the controller 220 may determine the external device 10-2, which is to be woken up, based on the wakeup start command and may transmit the wakeup signal through the housing unit 230-2 connected to the external device 10-2.

The controller 220 determines interface types of the connected external devices 10-1, 10-2, . . . , and 10-n and controls the switching units 240-1, 240-2, . . . , and 240-n to apply interfaces complying with the determined interface types. In more detail, the interface device 200 may transmit and receive various types of data and a control signal with the external devices 10-1, 10-2, . . . , and 10-n through an HDMI type and a new interface type. Here, the new interface type indicates an interface type complying with exemplary embodiments which will be described later. Hereinafter, a new interface will be referred to as an NIF. Therefore, the controller 220 determines whether the connected external devices 10-1, 10-2, . . . , and 10-n use an HDMI-type or an NIF-type and controls the switching units 240-1, 240-2, . . . , and 240-n respectively corresponding to the external devices 10-1, 10-2, . . . , and 10-n so as to use the determined interface type.

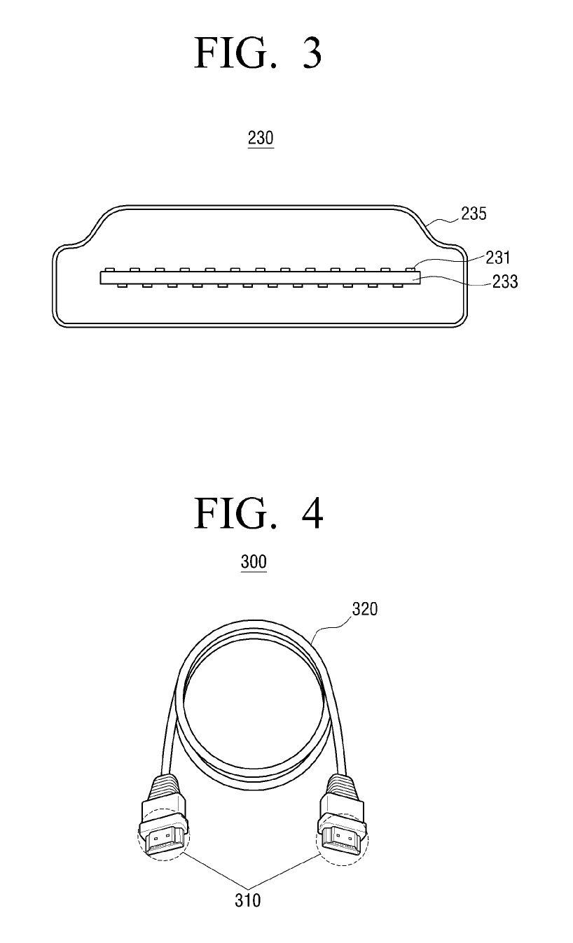

The housing units 230-1, 230-2, . . . , and 230-n are respectively connected to the external devices 10-1, 10-2, . . . , and 10-n through the cable connectors 300-1, 300-2, . . . , and 300-n. In more detail, the housing unit 230 may include a plurality of contact locations having numbers which are sequentially designated. Here, the contact locations are pins or terminals which are electrically connected to connectors 310 of the cable connectors 300-1, 300-2, . . . , and 300-n. Detailed shapes of the housing units 230-1, 230-2, . . . , and 230-n will be described later with reference to FIG. 3.

The switching units 240-1, 240-2, . . . , and 240-n are switched under control of the controller 220 so as to select an interface type corresponding to an interface type applied to the external devices 10-1, 10-2, . . . , and 10-n. As described with reference to FIG. 2, a plurality of switching units are installed so as to respectively correspond to housing units. However, some of housing units may be realized to be used only for a particular interface. In this case, the switching units may be realized so as to be included only in housing units supporting a plurality of interfaces.

FIG. 3 is a view illustrating a detailed shape of a housing unit 230 as shown in FIG. 2, according to an exemplary embodiment.

Referring to FIG. 3, the housing unit 230 includes a plurality of contact locations 231, a support part 233, and a metal support part 235. The housing unit 230 may have a shape compatible with an HDMI connector.

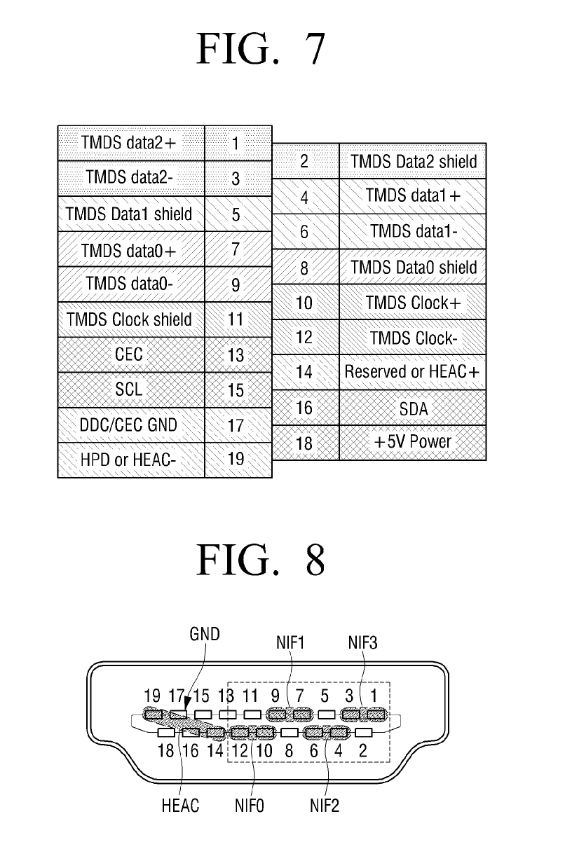

The plurality of contact locations 231 may have a pin arrangement as in an interface type as shown in FIGS. 6, 10, 13, 16 and 20 and may be compatible with an HDMI connector as shown in FIG. 7.

FIG. 4 is a view illustrating a cable connector 300 according to an exemplary embodiment.

Referring to FIG. 4, the cable connector 300 may be used to transmit an electric signal between two media player devices 100. In more detail, the cable connector 300 includes a cable 320 and connectors 310 which are positioned at both ends of the cable 230.

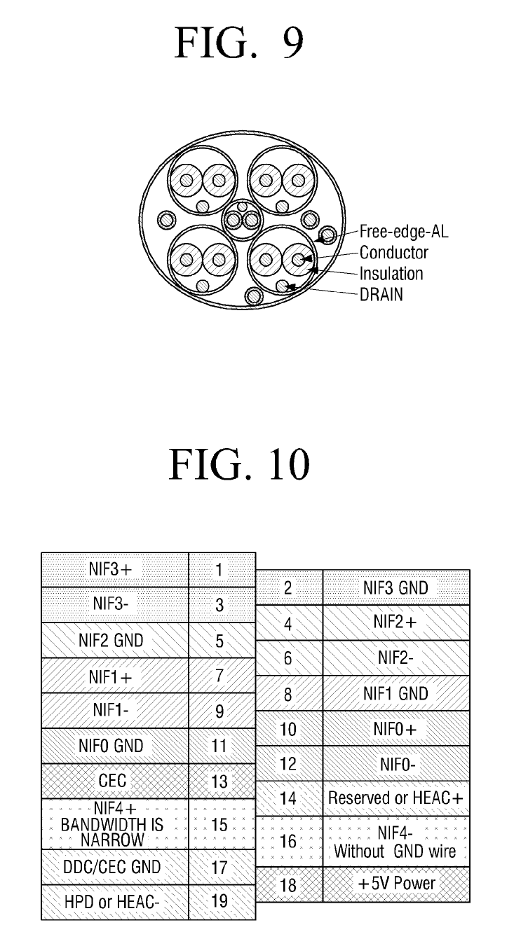

The cable 320 includes a sheath and one signal lines which are formed inside the sheath. If the cable connector 300 is connected to the two media player devices 100, an electric signal and power are transmitted between the two media player devices 100 through the one signal lines of the cable 320. The cable 320 may have a cross-section as shown in FIG. 9, 12, 14, 19, or 21.

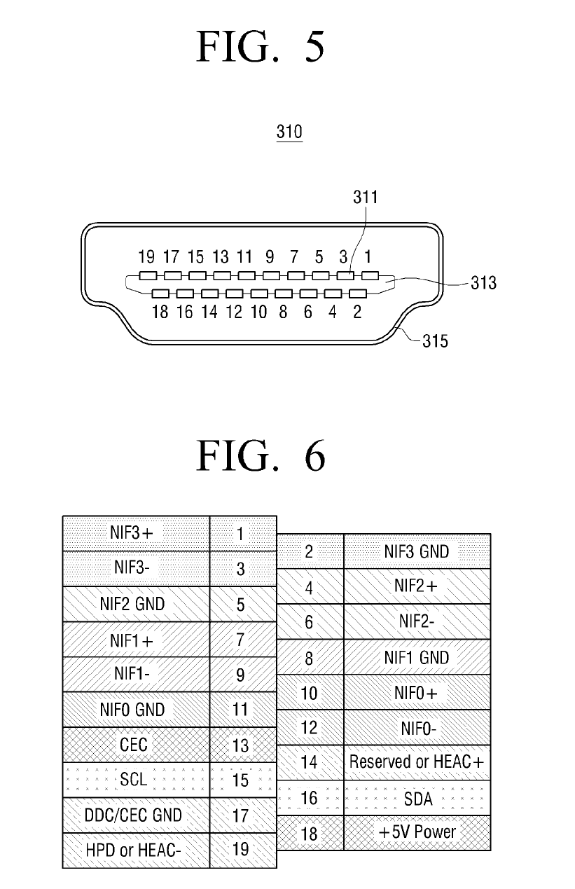

The connectors 310 are formed at the both ends of the cable 320. In more detail, each of the connectors 310 may include a plurality of contact locations having numbers which are sequentially designated. Here, the contact locations are pins or terminals which are electrically connected to the housing unit 230 which have been described above. Detailed shapes of the connectors 310 will be described later with reference to FIG. 5.

As described with reference to FIG. 4, the connectors 310 having the same shapes are formed at the both ends of the cable 320. However, connectors 310 having different shapes may be connected to the both ends of the cable 320. Also, one connector 310 may be positioned at a side of the cable 320, and a plurality of connectors may be disposed at the other end of the cable 320.

FIG. 5 is a view illustrating a detailed shape of a connector 310 as shown in FIG. 4, according to an exemplary embodiment.

Referring to FIG. 5, the connector 310 includes a plurality of contact locations 311 and housings 313 and 315 which fix and house the plurality of contact locations 311. The connector 310 may have a shape compatible with an HDMI connector.

The plurality of contact locations 311 may have a pin arrangement as in the interface type shown in FIG. 6, 10, 13, 16, or 20 and may be compatible with the HDMI connector as shown in FIG. 7.

FIG. 6 is a view illustrating an interface structure according to an exemplary embodiment.

In more detail, the interface structure according to the present exemplary embodiment includes a plurality of contact location groups which are to perform communications among a plurality of media player devices and contact locations which transmit various types of control signals and power. A contact location group is a set of pins or terminals which transmit and receive an A/V signal, a control signal, etc. between a pair of media player device via a differential signaling method.

Referring to FIG. 6, contact locations (or terminals) 1, 2, and 3 are a fourth device pair contact location group which is designated to transmit data between a fourth pair of devices. In more detail, the fourth device pair contact location group includes a fourth device pair plus contact location NF3+ and a fourth device pair minus contact location NIF3− for differential signaling and a fourth device pair ground contact location NIF3 GND for ground processing. The fourth device pair contact location group may correspond to TMDS data2+, TMDS data2 shield, and TMDS data2− which are Transmission Minimized Differential Signaling (TMDS) contact locations of an HDMI as shown in FIG. 7. Here, differential signaling refers to a technique for transmitting a pair of a signal and a signal having an opposite phase to that of the signal.

Also, contact locations 4, 5, and 6 are a third device pair contact location group which is designated to transmit data between a third pair of devices. In more detail, the third device pair contact location group includes a third device pair plus contact location NIF2+ and a third device pair minus contact location NIF2− for differential signaling and a third device pair ground contact location NIF2 GND for ground processing. The third device pair contact location group may correspond to TMDS data1+, TMDS data1 shield, and TMDS data1− of the HDMI as shown in FIG. 7.

Contact locations 7, 8, and 9 are a second device pair contact location group which is designated to transmit data between a second pair of devices. In more detail, the second device pair contact location group includes a second device pair plus contact location NIF1+ and a second device pair minus contact location NIF1− for differential signaling and a second device pair ground contact location NIF1 GND for ground processing. The second device pair contact location group may correspond to TMDS data0+, TMDS data0 shield, and TMDS data0− of the HDMI as shown in FIG. 7.

Contact locations 10, 11, and 12 are a first device pair contact location group which is designated to transmit data between a first pair of devices. In more detail, the first device pair contact location group includes a first device pair plus contact location NIF0+ and a first device pair minus contact location NIF0− for differential signaling and a first device pair ground contact location NIF GND for ground processing. The first device pair contact location group may correspond to TMDS Clock+, TMDS Clock shield, and TMDS Clock− of the HDMI as shown in FIG. 7.

A contact location 13 is a Consumer Electronics Control (CEC) contact location. In more detail, the CEC contact location is a contact location which is to transmit a control command between media player devices and may be used to perform a wakeup process in the present inventive concept.

Contact locations 14 and 19 are an Ethernet and Audio Return Channel (HEAC) contact location group. In more detail, the HEAC contact location group includes a HEAC plus contact location HEAC+ and a HEAC minus contact location HEAC−. The HEAC contact location group enables an Ethernet channel connection, an audio return, and a 3-dimensional (3D) image transmission.

A contact location 15 is a Serial Clock (SCL) contact location, and a contact location 16 is a Serial Data (SDL) contact location. The SCL contact location and the SDL contact location may be used to perform serial communications with an external media player device.

A contact location 17 is a ground contact location for ground processing.

A contact location 18 is a power contact location which is to transmit power. In more detail, the power contact location is a contact location which is to supply power.

As described above, the interface structure according to the present exemplary embodiment is compatible with the HDMI as shown in FIG. 7 and supports an interface which may be simultaneously connected to 4 media player devices.

As described with reference to FIG. 6, the contact locations 14 and 19 are used as the HEAC contact location group. However, the contact locations 14 and 19 may be used as a fifth device pair contact location group, which is designated to transmit data between a fifth pair of devices, along with a ground contact location DDC/CEC GND. The first through fifth device pair contact location groups may be represented on a connector as shown in FIG. 8. Also, if the interface structure described in the exemplary embodiment of FIG. 6 is used, the cable 320 of the cable connector 300 may have a cross-section as shown in FIG. 9.

FIG. 10 is a view illustrating an interface structure according to another exemplary embodiment.

Referring to FIG. 10, the interface structure according to the present exemplary embodiment includes a plurality of contact location groups which are to perform communications among a plurality of media player devices and contact locations which transmit various types of control signals and power.

Contact locations 1, 2, and 3 are a fourth device pair contact location group which is designated to transmit data between a fourth pair of devices. Contact locations 4, 5, and 6 are a third device pair contact location group which is designated to transmit data between a third pair of devices. Contact locations 7, 8, and 9 are a second device pair contact location group which is designated to transmit data between a second pair of devices. Contact locations 10, 11, and 12 are a first device pair contact location group which is designated to transmit data between a first pair of devices. The first through fourth device pair contact location groups perform the same functions as the first through fourth device pair contact location groups described with reference to FIG. 6, and thus their repeated descriptions will be omitted herein.

Contact locations 15 and 16 are a fifth device pair contact location group which is designated to transmit data between a fifth pair of devices. In more detail, the fifth device pair contact location group includes a fifth device pair plus contact location NIF4+ and a fifth device pair minus contact location NIF4−. The fifth device pair contact location group may correspond to the SCL and the SDA of the HDMI as shown in FIG. 7.

A contact location 13 is a CEC contact location, and contact locations 14 and 19 are a HEAC contact location group. A contact location 17 is a ground contact location for ground processing, and a contact location 18 is a power contact location which transmits power. The contact locations 13, 14, 17, 18, and 19 perform the same functions as the contact locations 13, 14, 17, 18, and 19 of FIG. 6, and thus their repeated descriptions will be omitted herein.

As described above, the interface structure according to the present exemplary embodiment is compatible with the HDMI as shown in FIG. 7 and supports an interface which may be simultaneously connected to 5 media player devices.

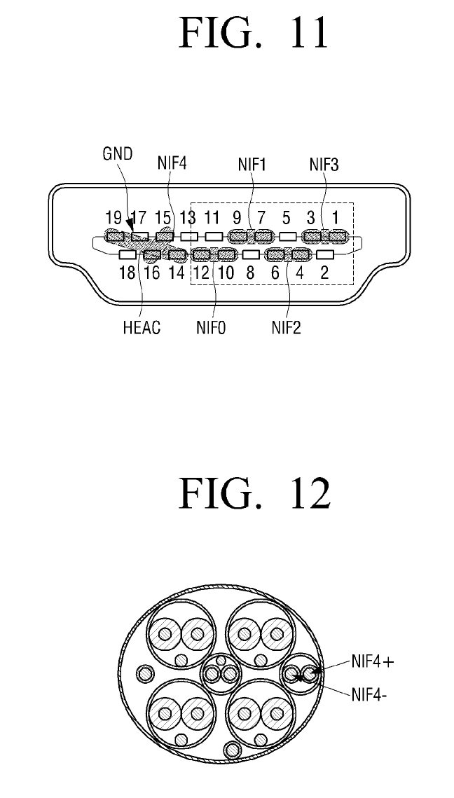

As described with reference to FIG. 10, the contact locations 14 and 19 are used as the HEAC contact location group. However, the contact locations 14 and 19 may be used as a sixth device pair contact location group, which is to transmit data between a sixth pair of devices, along with the ground contact location DDC/CEC GND. The first through sixth device pair contact location groups may be represented on a connector as shown in FIG. 11. If the interface structure according to the exemplary embodiment of FIG. 10 is used, the cable 320 of the connector 300 may have a cross-section as shown in FIG. 12.

FIG. 13 is a view illustrating an interface structure according to another exemplary embodiment.

Referring to FIG. 13, the interface structure of the present exemplary embodiment includes a plurality of contact location groups which are to perform communications among a plurality of media player devices and contact locations which transmit various types of control signals and power.

Contact locations 1, 2, and 3 are a fourth device pair contact location group which is designated to transmit data between a fourth pair of devices. Contact locations 4, 5, and 6 are a third device pair contact location group which is designated to transmit data between a third pair of devices. Contact locations 7, 8, and 9 are a second device pair contact location group which is designated to transmit data between a second pair of devices. Contact locations 10, 11, and 12 are a first device pair contact location group which is designated to transmit data between a first pair of devices. The first through fourth device pair contact location groups perform the same functions as the first through fourth device pair contact location groups described with reference to FIG. 6, and thus their repeated descriptions will be omitted herein.

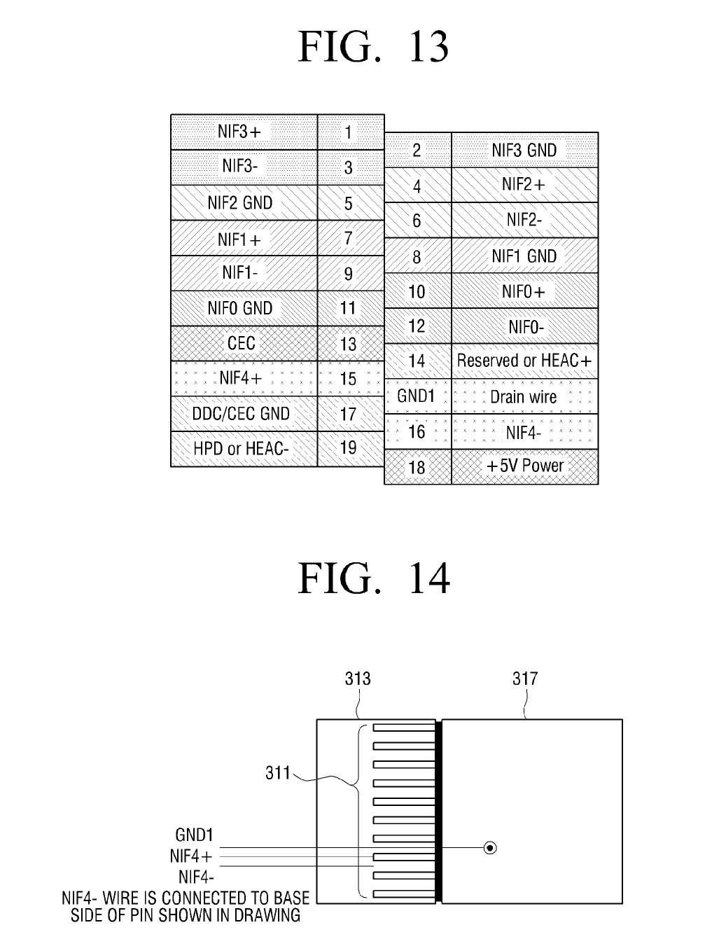

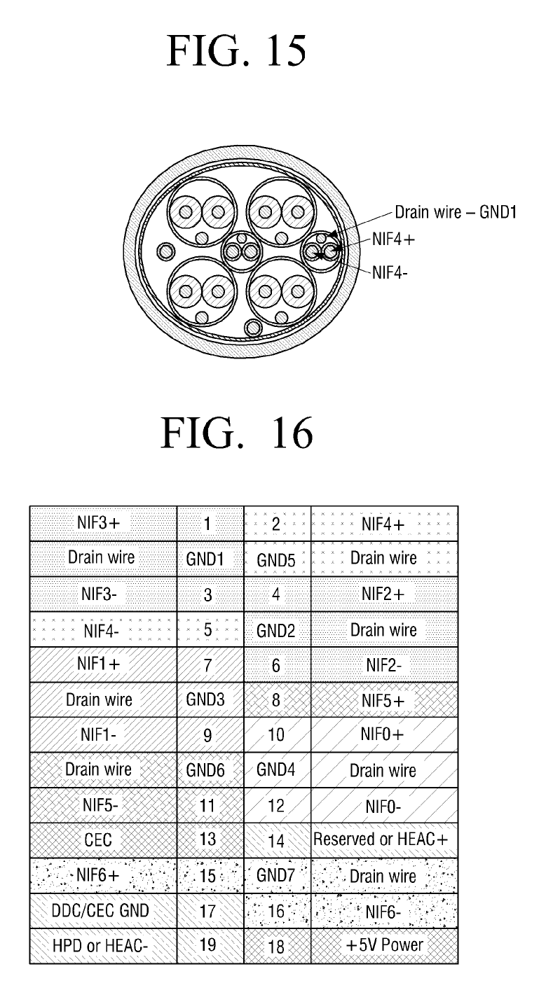

Contact locations 15 and 16 and a drain wire are a fifth device pair contact location group which is designated to transmit data between a fifth pair of devices. In more detail, the fifth device pair contact location group includes a fifth device pair plus contact location NIF4+ and a fifth device pair minus contact location NIF4− for differential signaling and the drain wire GND1 for ground processing. The drain wire is a wire which is included in a cable as shown in FIG. 14. The drain wire is connected to the metal ground part 317 of the connector 310 as shown in FIG. 15. The metal ground part 317 may be connected to one of the ground locations (the contact locations 2, 5, 8, 11, and 17) of the above-described pair contact location groups on the connector 310. In the present exemplary embodiment, the fifth device pair contact location group is ground-processed using the drain wire. However, the fifth device pair contact location group may be ground-processed directly using one of the ground contact locations (the contact locations 2, 5, 8, 11, and 17) of the first through fourth device pair contact location groups.

A contact location 13 is a CEC contact location, and contact locations 14 and 19 are a HEAC contact location group. A contact location 17 is a ground contact location for ground processing, and a contact location 18 is a power contact location which transmits power. Functions of the contact locations 13, 14, 17, 18, and 19 are the same as those of the contact locations 13, 14, 17, 18, and 19 of FIG. 6, and thus their repeated descriptions will be omitted herein.

As described above, the interface structure according to the present exemplary embodiment is compatible with the HDMI as shown in FIG. 7 and supports an interface which may be simultaneously connected to 5 media player devices. When compared to the previous exemplary embodiment of FIG. 10, the fifth device pair contact location group of FIG. 10 does not include a contact location for ground processing and thus may have a lower bandwidth performance than the other contact location groups. However, the fifth device pair contact location group according to the exemplary embodiment of FIG. 13 may improve a bandwidth performance which is ground-processed through the drain wire or a ground contact location of another contact location group.

As described with reference to FIG. 13, the contact locations 14 and 19 are used as the HEAC contact location group. However, the contact locations 14 and 19 may be used as a sixth device pair contact location group which is to transmit data between a six pair of devices, along with the ground contact location DDC/CEC GND. If the interface structure according to the present exemplary embodiment is used, the cable 320 of the cable connector 300 may have a cross-section as shown in FIG. 15.

FIG. 16 is a view illustrating an interface structure according to an exemplary embodiment.

Referring to FIG. 16, the interface structure according to the present exemplary embodiment includes a plurality of contact location groups which are to perform communications among a plurality of media player devices and contact locations which transmit various types of control signals and power.

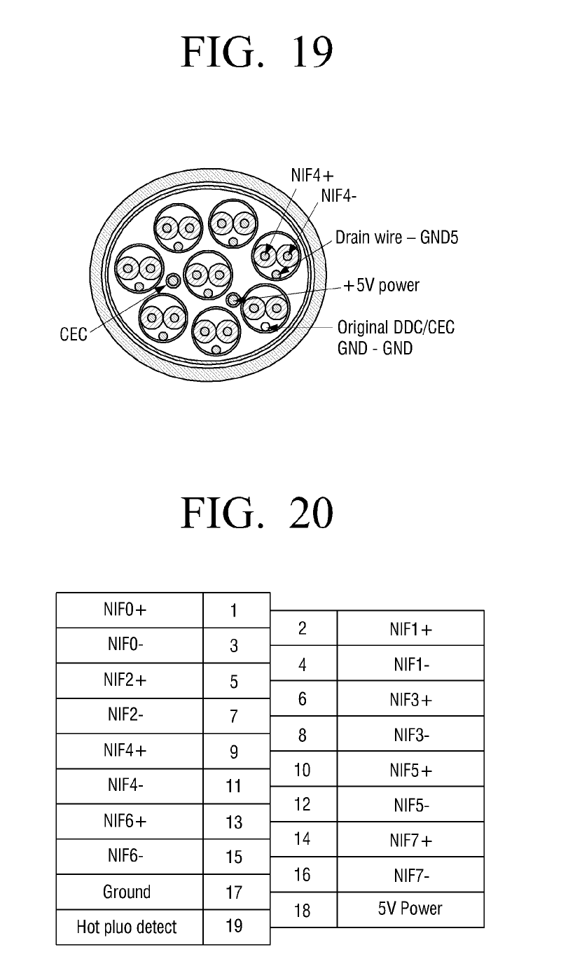

Referring to FIG. 16, contact locations 1 and 3 are a fourth device pair contact location group which is designated to transmit data between a fourth pair of devices. In more detail, the fourth device pair contact location group includes a fourth device pair plus contact location NIF3+ and a fourth device pair minus contact location NIF3− for differential signaling and a drain wire GND1 for ground processing. The drain wire GND1 is an additional wire of an internal cable which transmits signals of the fourth device pair plus contact location NIF3+ and the fourth device pair minus contact location NIF3− of the cable 320 as shown in FIG. 19. The drain wire GND1 is connected to the metal ground part 317 of the connector 310 as shown in FIG. 18. The metal ground part 317 may be connected to one of the ground contact locations (the contact locations 2, 5, 8, 11, and 17) of the above-described pair contact location groups on the connector 310. The fourth device pair contact location group may correspond to TMDS contact locations TMDS data2+ and TMDS data2− of the HDMI as shown in FIG. 7.

Contact locations 2 and 5 are a fifth device pair contact location group which is designated to transmit data between a fifth pair of devices. In more detail, the fifth device pair contact location group includes a fifth device pair plus contact location NIF4+ and a fifth device pair minus contact location NIF4− for differential signaling and a drain wire GND5 for ground processing. Here, the drain wire GND5 is an additional wire of an internal cable which transmits signals of a fifth device pair plus contact location NIF4+ and a fifth device pair minus contact location NIF4− of the cable 320 as shown in FIG. 19. The fifth device pair contact location group may correspond to TMDS data2 Shield and TMDS data1 Shield of the HDMI as shown in FIG. 7.

Contact locations 4 and 6 are a third device pair contact location group which is designated to transmit data between a third pair of devices. In more detail, the third device pair contact location group includes a third device pair plus contact location NIF2+ and a third device pair minus contact location NIF2− for differential signaling and a drain wire GND2 for ground processing. Here, the drain wire GND2 is an additional wire of an internal cable which transmits signals of the third device pair plus contact location NIF2+ and the third device pair minus contact location NIF2− of the cable 320 as shown in FIG. 19. The third device pair contact location group may correspond to TMDS data1+ and TMDS data1− of the HDMI as shown in FIG. 7.

Contact locations 7 and 9 are a second device pair contact location group which is designated to transmit data between a second pair of devices. In more detail, the second device pair contact location group includes a second device pair plus contact location NIF1+ and a second device pair minus contact location NIF1− for differential signaling and a drain wire GND3 for ground processing. The drain wire GND3 is an additional wire of an internal cable which transmits signals of the second device pair plus contact location NIF1+ and the second device pair minus contact location NIF1− of the cable 320 as shown in FIG. 19. The second device pair contact location group may correspond to TMDS data0+ and TMDS data0− of the HDMI as shown in FIG. 7.

Contact locations 8 and 11 are a sixth device pair contact location group which is designated to transmit data between a sixth pair of devices. In more detail, the sixth device pair contact location group includes a sixth device pair plus contact location NIF5+ and a sixth device pair minus contact location NIF5− for differential signaling and a drain wire GND6 for ground processing. The drain wire GND6 is an additional wire of an internal cable which transmits signals of the sixth device pair plus contact location NIF5+ and the sixth device pair minus contact location NIF5− of the cable 320 as shown in FIG. 19. The sixth device pair contact location group may correspond to TMDS data0 Shield and TMDS Clock shield of the HDMI as shown in FIG. 7.

Contact locations 10 and 12 are a first device pair contact location group which is designated to transmit data between a first pair of devices. In more detail, the first device pair contact location group includes a first device pair plus contact location NIF0+ and a first device pair minus contact location NIF0− for differential signaling and a drain wire GND4 for ground processing. The drain wire GND 4 is an additional wire of an internal cable which transmits signals of the first device pair plus contact location NIF1+ and the first device pair minus contact location NIF1− of the cable 320 as shown in FIG. 19. The first device pair contact location group may correspond to TMDS Clock+ and TMDS Clock− of the HDMI as shown in FIG. 7.

Contact locations 15 and 16 are a seventh device pair contact location group which is designated to transmit data between a seventh pair of devices. In more detail, the seventh device pair contact location group includes a seventh device pair plus contact location NIF6+ and a seventh device pair minus contact location NIF6− for differential signaling and a drain wire GND7 for ground processing. The drain wire GND7 is an additional wire of an internal cable which transmits signals of the seventh device pair plus contact location NIF6+ and the seventh device pair minus contact location NIF6− of the cable 320 as shown in FIG. 19. The seventh device pair contact location group may correspond to the SCL and the SDA of the HDMI as shown in FIG. 7. A contact location 13 is a CEC contact location. In more detail, the CEC contact location is a contact location which is to transmit a control command between media player devices and may be used to perform a wakeup process in the present inventive concept.

Contact locations 14 and 19 are a HEAC contact location group. In more detail. The HEAC contact location group includes a HEAC plus contact location HEAC+ and a HEAC minus contact location HEAC−.

A contact location 17 is a ground contact location for ground processing.

A contact location 18 is a power contact location which transmits power. In more detail, the power contact location is a contact location which is to supply 5V direct current (DC) power.

The interface structure according to the present exemplary embodiment is compatible with the HDMI as shown in FIG. 7 and may be connected to 7 media player devices.

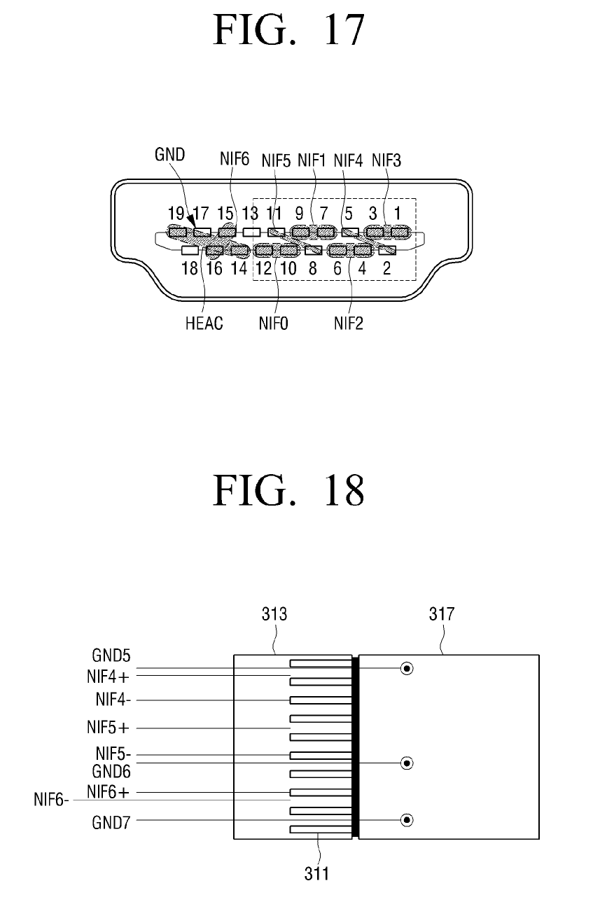

As described with reference to FIG. 16, the contact locations 14 and 19 are used as the HEAC contact location group. However, the contact locations 14 and 19 may be used as an eighth device pair contact location group which is to transmit data between an eighth pair of devices, along with the ground contact DDC/CEC GND. The first through eighth device pair contact location groups may be represented on a connector as shown in FIG. 17. If the interface structure according to the present exemplary embodiment is used, a cable of the cable connector 300 may have a cross-section as shown in FIG. 19.

FIG. 20 is a view illustrating an interface structure according to another exemplary embodiment.

Referring to FIG. 20, the interface structure according to the present exemplary embodiment includes a plurality of contact location groups which are to perform communications among a plurality of media player devices and contact locations which transmit various types of control signals and power.

Contact locations 1 and 3 are a first device pair contact location group which is designated to transmit data between a first pair of devices. In more detail, the first device pair contact location group includes a first device pair plus contact location NIF0+ and a first device pair minus contact location NIF0− for differential signaling. The first device pair contact location group may correspond to TMDS contact locations TMDS data2+ and TMDS data2− of the HDMI as shown in FIG. 7.

Contact locations 2 and 4 are a second device pair contact location group which is designated to transmit data between a second pair of devices. In more detail, the second device pair contact location group includes a second device pair plus contact location NIF1+ and a second device pair minus contact location NIF1− for differential signaling. The second device pair contact location group may correspond to TMDS data2 Shield and TMDS data1+ of the HDMI as shown in FIG. 7.

Contact locations 5 and 7 are a third device pair contact location group which is designated to transmit data between a third pair of devices. In more detail, the third device pair contact location group includes a third device pair plus contact location NIF2+ and a third device pair minus contact location NIF2− for differential signaling. The third device pair contact location group may correspond to TMDS contact locations TMDS data1 shield and TMDS data0+ of the HDMI as shown in FIG. 7.

Contact locations 6 and 8 are a fourth device pair contact location group which is designated to transmit data between a fourth pair of devices. The fourth device pair contact location group includes a fourth device pair plus contact location NIF3+ and a fourth device pair minus contact location NIF3− for differential signaling. The fourth device pair contact location group may correspond to TMDS data1− and TMDS data0 shield of the HDMI as shown in FIG. 7.

Contact locations 9 and 11 are a fifth device pair contact location group which is designated to transmit data between a fifth pair of devices. In more detail, the fifth device pair contact location group includes a fifth device pair plus contact location NIF4+ and a fifth device pair minus contact location NIF4− for differential signaling. The fifth device pair contact location group may correspond to TMDS data0− and TMDS Clock shield of the HDMI as shown in FIG. 7.

Contact locations 10 and 12 are a sixth device pair contact location group which is designated to transmit data between a sixth pair of devices. In more detail, the sixth device pair contact location group includes a sixth device pair plus contact location NIF5+ and a sixth device pair minus contact location NIF5− for differential signaling. The sixth device pair contact location group may correspond to TMDS Clock+ and TMDS Clock− of the HDMI as shown in FIG. 7.

Contact locations 13 and 15 are a seventh device pair contact location group which is designated to transmit data between a seventh pair of devices. In more detail, the seventh device pair contact location group includes a seventh device pair plus contact location NIF6+ and a seventh device pair minus contact location NIF6− for differential signaling. The seventh device pair contact location group may correspond to the CEC and the SCL of the HDMI as shown in FIG. 7.

Contact locations 14 and 15 are an eighth device pair contact location group which is designated to transmit data between an eighth pair of devices. In more detail, the eighth device pair contact location group includes an eighth device pair plus contact location NIF7+ and an eighth device pair minus contact location NIF7− for differential signaling. The eighth device pair contact location group may correspond to HEAC+ and SDA of the HDMI as shown in FIG. 7.

A contact location 17 is a ground contact location for ground processing.

A contact location 18 is a power contact location which transmits power. In more detail, the power contact location is a contact location which is to supply power.

A contact location 19 is a contact location which is to detect a hot plug.

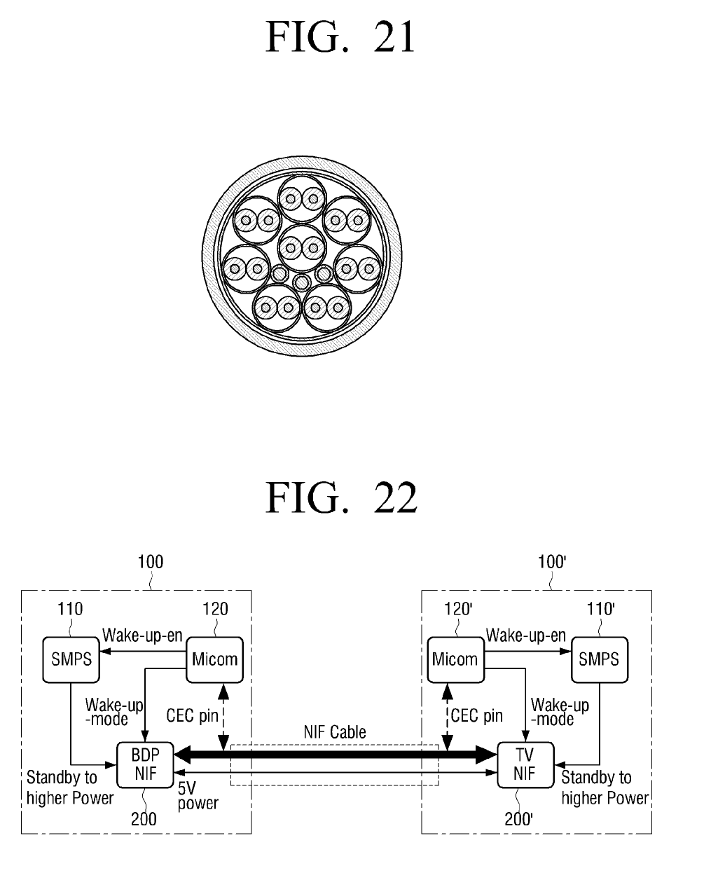

As described above, the interface structure according to the present exemplary embodiment is compatible with the HDMI as shown in FIG. 7 and may be connected to 8 media player devices. If the interface structure according to the present exemplary embodiment is used, the cable of the cable connector 300 may have a cross-section as shown in FIG. 21.

FIG. 22 is a view illustrating a method of charging and waking up an external device connected to the interface device 200 through an interface as described above, according to an exemplary embodiment.

Referring to FIG. 22, the interface device 200 may be connected to an external device 100′ through a cable connector and recognize the connection of the external device 100′ using one of a plurality of contact locations of a connector. In more detail, the interface device 200 may check whether the external device 100′ is a chargeable device, via a CEC contact location of the plurality of contact locations which are connected to the interface device 200. If the external device 100′ is the chargeable device, the interface device 200 may inform a microcomputer 120 that the chargeable device has been connected thereto. In the present exemplary embodiment, the interface device 200 recognizes a connection of an external device. However, the microcomputer 120 may recognize the connection of the external device.

If a media player device 100 is in a standby mode, the interface device 200 may transmit a wakeup signal to the microcomputer 120. The microcomputer 120, which has received the wakeup signal and a signal for signaling that a chargeable device has been connected, may control a power supply unit 110 to output power complying with a wakeup mode of the wakeup signal. If the power supply unit 110 outputs power complying with the wakeup mode, the interface device 200 may supply the corresponding power to the external device 100′ to charge the external device 100′.

As described with reference to FIG. 22, the external device 100′ is charged using a power contact location. However, as shown in FIG. 26, power may be supplied to the external device 100′ using a plurality of contact locations. In other words, a further sufficient amount of current may be supplied to the external device 100′ using a plurality of lines. Here, the above-described power contact location and a contact location group for transmitting an audio/visual (A/V) signal may be used as the lines. Power may be supplied to the external device 100′ using two contact location groups or three contact location groups.

An operation of waking up the external device 100′ will now be described with reference to FIG. 22.

If the external device 100′ is to be woken up, the microcomputer 120 may transmit a wakeup start command as shown in FIG. 24 to the interface device 200 to wake up the external device 100′. Here, the wakeup start command a start field which is to acknowledge a start of a wakeup command, a wakeup port field which is to acknowledge a device which is to be woken up, and a wakeup mode field which is to acknowledge a mode of a wakeup, and an Ack signal field.

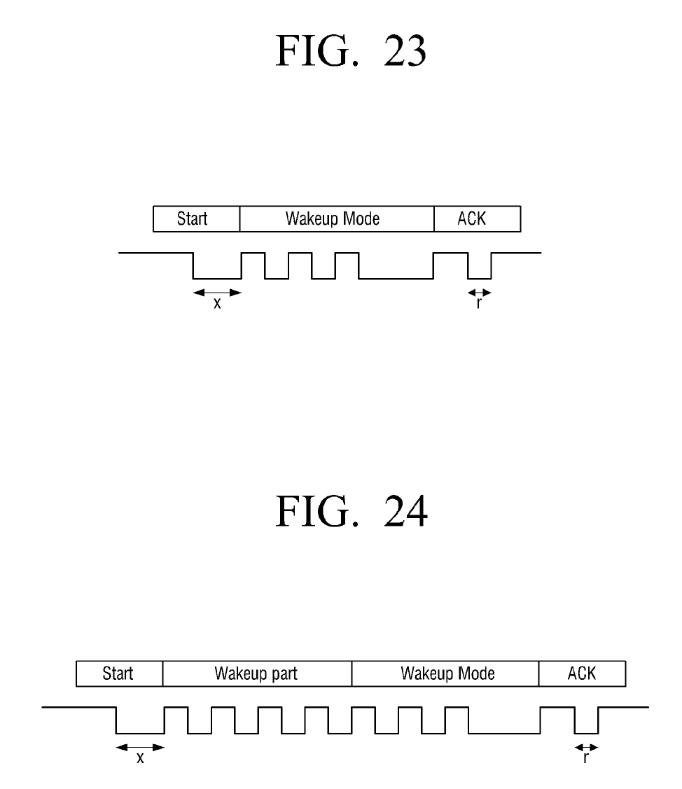

The interface device 200, which has received the wakeup start command, may determine an external device, which is to be woken up, with reference to the wakeup port field of the wakeup start command, and transmit a wakeup signal as shown in FIG. 23 to a housing unit connected to the corresponding external device, i.e., the corresponding external device. Here, the wakeup signal may include a start field which is to acknowledge a start of a wakeup command of a wakeup start command not including a wakeup port field, a wakeup mode field which is to acknowledge a mode of a wakeup, and an Ack signal field.

Here, the interface device 200 may transmit the wakeup signal to the external device 100′ via a CEC contact location of a plurality of contact locations.

As described in the present exemplary embodiment, the media player device 100 generates and transmits a wakeup start command with respect to a particular external device. However, the wakeup start command may be received from the external device 100′.

In more detail, if the interface device 200 receives a wakeup start command with respect to the external device 10-2 from the external device 10-1, the interface device 200 may determine an external device, which is to be woken up, with reference to a wakeup port field of the wakeup start command, and transmit a wakeup signal to the determined external device.

FIG. 23 is a view illustrating a structure of a wakeup signal according to an exemplary embodiment.

Referring to FIG. 23, the wakeup signal includes a start field, a wakeup mode filed, and an Ack signal field.

The start field is a field which is to acknowledge a start of a wakeup command and may be a signal which continues for a preset time set after it falls from a high level to a low level. Alternatively, the signal may continue for a preset time after it rises from the low level to the high level.

The wakeup mode field is a field which is to acknowledge a mode of a wakeup and may have a mode as shown in FIG. 26.

The Ack signal field is a signal through which the external device 100′, which has received the wakeup signal, informs the interface device 200, which has transmitted the wakeup signal, that the external device 100′ has received the wakeup signal.

FIG. 24 is a view illustrating a structure of a wakeup start command according to an exemplary embodiment.

Referring to FIG. 24, the wakeup start command includes a start field, a wakeup port field, a wakeup mode field, and an Ack signal field.

The start field is a field which is to acknowledge a start of a wakeup command and may be a signal which continues for a preset time after it falls from a high level to a low level. The start field may be a signal which continues for a preset time after it rises from the low level to the high level.

The wakeup port field is a field which is to acknowledge a media player device which is to be woken up.

The wakeup mode field is a field which is to acknowledge a mode of a wakeup and may have a mode as shown in FIG. 26.

The Ack signal field is a signal through which the external device 100′ which has received the wakeup signal informs the interface device 200 that the external device 100′ has received the wakeup signal.

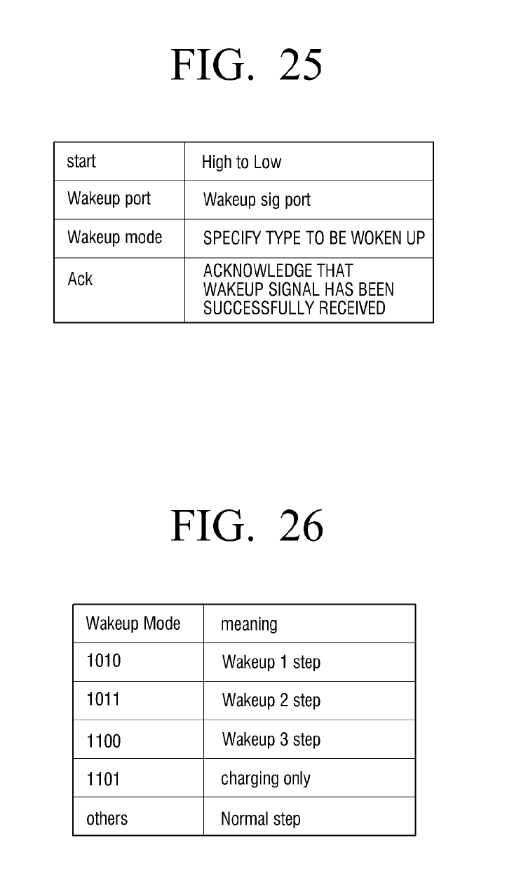

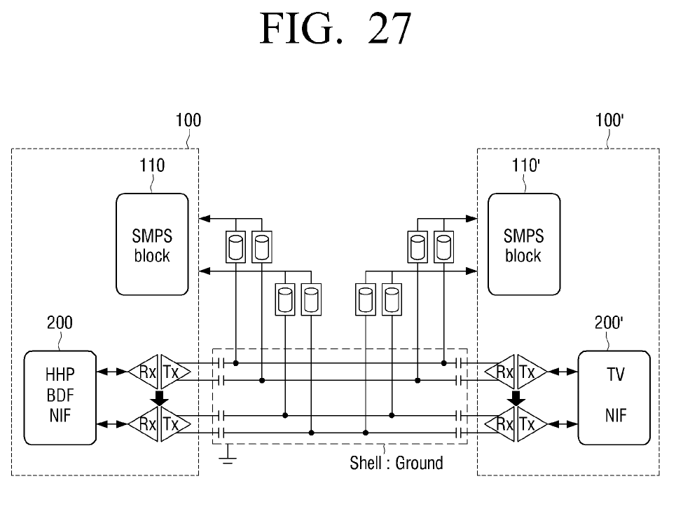

FIG. 25 is a view illustrating roles of signals of a wakeup start command according to an exemplary embodiment.

Referring to FIG. 25, a start field is a field to which a signal falling from a high level to a low level is transmitted. A wakeup port field is a field to which a signal designating a port corresponding to a particular external device of a plurality of external devices is transmitted. A wakeup mode field is a field to which a signal designating an operation mode of an external device is transmitted. An Ack signal field is a field to which a signal acknowledging that a wakeup signal has been successfully received is transmitted.

FIG. 26 is a view illustrating types of the wakeup mode of FIG. 25.

Referring to FIG. 26, the wakeup mode includes a plurality of wakeup modes Wakeup 1 step, Wakeup 2 step, and Wakeup 3 step respectively corresponding to a plurality of operation modes of a media player device and a charging only mode. As described above, various types of operation modes of an external device may be designated according to signals as described above to wake up the external device 100′.

The foregoing exemplary embodiments are merely exemplary and are not to be construed as limiting the present inventive concept. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A connector which connects to media player devices, the connector comprising:
a plurality of contact locations having sequentially designated numbers; and
a housing which houses the plurality of contact locations,
wherein the plurality of contact locations comprise:
a first device pair contact location group which is configured to transmit first data between a first pair of devices;
a second device pair contact location group which is configured to transmit data between a second pair of devices;
a third device pair contact location group which is configured to transmit data between a third pair of devices; and
a fourth device pair contact location group which is configured to transmit data between a fourth pair of devices.

2. The connector as claimed in claim 1, wherein the first device pair contact location group comprises a first device pair plus contact location and a first device pair minus contact location for differential signaling, and a first device pair ground contact location.

3. The connector as claimed in claim 1, wherein the connector is compatible with a High-Definition Multimedia Interface connector.

4. The connector as claimed in claim 1, wherein the connector is a 19-pin connector.

5. The connector as claimed in claim 1, wherein at least one of the plurality of contact locations comprises a power transmission contact location which transmits power.

6. The connector as claimed in claim 1, wherein the plurality of contact locations further comprise a Consumer Electronics Control contact location.

7. The connector as claimed in claim 1, wherein the connector is compatible with a High-Definition Multimedia Interface (HDMI) connector, and the first device pair contact location group corresponds to a Transition Minimized Differential Signaling contact location.

8. The connector as claimed in claim 1, wherein:
the first device pair contact location group is designated as numbers from 10 to 12;
the second device pair contact location group is designated as numbers from 7 to 9;
the third device pair contact location group is designated as numbers from 4 to 6; and
the fourth device pair contact location group is designated as numbers from 1 to 3.

9. The connector as claimed in claim 1, wherein the plurality of contact locations further comprises a fifth device pair contact location group which is configured to transmit data between a fifth pair of devices.

10. The connector as claimed in claim 9, wherein the connector is compatible with a High-Definition Multimedia Interface (HDMI) connector, and the fifth device pair contact location group corresponds to an Ethernet and Audio Return Channel (HEAC) of the HDMI connector.

11. The connector as claimed in claim 9, wherein the fifth device pair contact location group is ground-processed via at least one of a ground contact location and a drain wire of another contact location group.

12. The connector as claimed in claim 9, wherein the fifth device pair contact location group is designated as numbers 14, 17, and 19.

13. The connector as claimed in claim 1, wherein the plurality of contact locations further comprise a sixth device pair contact location group which is configured to transmit data between a sixth pair of devices.

14. The connector as claimed in claim 13, wherein the connector is compatible with a High-Definition Multimedia Interface (HDMI) connector, and the sixth device pair contact location group corresponds to a serial data contact location and a serial clock contact location of the HDMI connector.

15. The connector as claimed in claim 13, wherein the sixth device pair contact location group is ground-processed via at least one of a ground contact location and a drain wire of another contact location group.

16. The connector as claimed in claim 13, wherein the sixth device pair contact location group is designated as numbers 15 and 16.

17. A connector which connects to media player devices, the connector comprising:
a plurality of contact locations having sequentially designated numbers; and
a housing which houses the plurality of contact locations,
wherein the plurality of contact locations comprises:
a first device pair contact location group which is configured to transmit data between a first pair of devices;
a second device pair contact location group which is configured to transmit data between a second pair of devices;
a third device pair contact location group which is configured to transmit data between a third pair of devices;
a fourth device pair contact location group which is configured to transmit data between a fourth pair of devices;
a fifth device pair contact location group which is configured to transmit data between a fifth pair of devices;
a sixth device pair contact location group which is configured to transmit data between a sixth pair of devices;
a seventh device pair contact location group which is configured to transmit data between a seventh pair of devices; and
an eighth device pair contact location group which is configured to transmit data between an eighth pair of devices.

18. The connector as claimed in claim 17, wherein the first device pair contact location group comprises a first device pair plus contact location and a first device pair minus contact location for differential signaling.

19. The connector as claimed in claim 17, wherein the connector is compatible with a High-Definition Multimedia Interface connector.

20. The connector as claimed in claim 17, wherein the connector is a 19-pin connector.

21. The connector as claimed in claim 17, wherein the plurality of contact locations further comprise a power transmission contact location which transmits power.

22. The connector as claimed in claim 17, wherein at least one of the plurality of contact locations comprises a Consumer Electronics Control contact location.

23. The connector as claimed in claim 17, wherein the connector is compatible with a High-Definition Multimedia Interface (HDMI) connector, and the first device pair contact location group corresponds to a Transition Minimized Differential Signaling contact location of the HDMI connector.

24. The connector as claimed in claim 17, wherein:
the first device pair contact location group is designated as numbers 10 and 12;
the second device pair contact location group is designated as numbers 7 and 9;
the third device pair contact location group is designated as numbers 4 and 6;
the fourth device pair contact location group is designated as numbers 1 and 3;
the fifth device pair contact location group is designated as numbers 2 and 5;
the sixth device pair contact location group is designated as numbers 8 and 11;
the seventh device pair contact location group is designated as numbers 15 and 16; and
the eighth device pair contact location group is designated as numbers 14 and 19.

25. The connector as claimed in claim 17, wherein at least one of the plurality of contact locations comprises a contact location for ground processing, which is designated as number 17,
wherein the eighth device pair contact location group uses the contact location, which is designated as the number 17, as a ground contact location.

26. The connector as claimed in claim 17, wherein at least one of the plurality of device pair contact location groups is ground-processed via at least one of a ground contact location and a drain wire of another device pair contact location group.

27. The connector as claimed in claim 17, wherein the connector is compatible with a High-Definition Multimedia Interface (HDMI) connector, and the eighth device pair contact location group corresponds to a Ethernet and Audio Return Channel (HEAC) contact location of the HDMI connector.

28. The connector as claimed in claim 17, wherein the connector is compatible with a High-Definition Multimedia Interface (HDMI) connector, and the seventh device pair contact location group corresponds to a serial data contact location and a serial clock contact location of the HDMI connector.

29. An interface device which interfaces media player devices, the interface device comprising:
a plurality of contact locations having numbers which are sequentially designated; and
a housing unit which comprises the plurality of contact locations,
wherein the plurality of contact locations comprises:
a first device pair contact location group which is configured to transmit data between a first pair of devices;
a second device pair contact location group which is configured to transmit data between a second pair of devices;
a third device pair contact location group which is configured to transmit data between a third pair of devices; and
a fourth device pair contact location group which is configured to transmit data between a fourth pair of devices.

30. The interface device as claimed in claim 29, wherein the first device pair contact location group comprises a first device pair plus contact location and a first device pair minus contact location for differential signaling, and a first device pair ground contact location.

31. The interface device as claimed in claim 29, wherein the housing unit is compatible with a High-Definition Multimedia Interface housing unit.

32. The interface device as claimed in claim 29, wherein the housing unit is a 19-pin housing unit.

33. The interface device as claimed in claim 29, wherein at least one of the plurality of contact locations comprises a power transmission contact location.

34. The interface device as claimed in claim 29, wherein at least one of the plurality of contact locations comprises a Consumer Electronics Control contact location.

35. The interface device as claimed in claim 29, wherein the housing unit is compatible with a High-Definition Multimedia Interface housing unit, and the first device pair contact location group corresponds to a Transition Minimized Differential Signaling contact location.

36. The interface device as claimed in claim 29, wherein:
the first device pair contact location group is designated as numbers from 10 to 12;
the second device pair contact location group is designated as numbers from 7 to 9;
the third device pair contact location group is designated as numbers from 4 to 6; and
the fourth device pair contact location group is designated as numbers from 1 to 3.

37. The interface device as claimed in claim 29, wherein the plurality of contact locations further comprise a fifth device pair contact location group which is configured to transmit data between a fifth pair of devices.

38. The interface device as claimed in claim 37, wherein the housing unit is compatible with a High-Definition Multimedia Interface housing unit, and the fifth device pair contact location group corresponds to a Ethernet and Audio Return Channel contact location.

39. The interface device as claimed in claim 37, wherein the fifth device pair contact location group is ground-processed via at least one of a ground contact location and a drain wire of another contact location group.

40. The interface device as claimed in claim 37, wherein the fifth device pair contact location group is designated as numbers 14, 17, and 19.

41. The interface device as claimed in claim 29, wherein the plurality of contact locations further comprise a sixth device pair contact location group which is configured to transmit data between a sixth pair of devices.

42. The interface device as claimed in claim 41, wherein the housing unit is compatible with a High-Definition Multimedia Interface housing unit, and the sixth device pair contact location group corresponds to a serial data contact location and a serial clock contact location.

43. The interface device as claimed in claim 41, wherein the sixth device pair contact location group is ground-processed via at least one of a ground contact location and a drain wire of another contact location group.

44. The interface device as claimed in claim 41, wherein the sixth device pair contact location group is designated as numbers 15 and 16.

45. The interface device as claimed in claim 29, wherein the interface device transmits and receives a wakeup signal, wherein the wakeup signal wakes up a media player device from a standby mode.

46. The interface device as claimed in claim 45, wherein at least one of the plurality of contact locations comprises a Consumer Electronics Control (CEC) contact location,
wherein the CEC contact location transmits and receives the wakeup signal with the media player device.

47. The interface device as claimed in claim 45, wherein the wakeup signal comprises a start field which acknowledges a start of a wakeup command, a wakeup mode field which acknowledges a wakeup mode, and an Ack signal field.

48. The interface device as claimed in claim 47, wherein the mode of the wakeup comprises a plurality of wakeup modes, which respectively correspond to a plurality of operation modes of a media player device, and a charging mode.

49. The interface device as claimed in claim 45, wherein if the interface device receives a wakeup start command from a microcomputer, the interface device determines an external media player device, based on the wakeup start command.

50. The interface device as claimed in claim 49, wherein the wakeup start command comprises a start field which acknowledges a start of a wakeup command, a wakeup port filed which acknowledges a device to be woken up, a wakeup mode field which acknowledges a wakeup mode, and an Ack signal field.

51. The interface device as claimed in claim 29, wherein the interface device transmits and receives power with an external media player device via at least two contact locations of the plurality of contact locations.

52. The interface device as claimed in claim 51, wherein at least one of the at least two contact locations, which transmit and receive the power, is an audio/video data transmission contact location.

53. The interface device as claimed in claim 29, wherein:
the first device pair contact location group is designated as numbers 10 and 12;
the second device pair contact location group is designated as numbers 7 and 9;
the third device pair contact location group is designated as numbers 4 and 6; and
the fourth device pair contact location group is designated as numbers 1 and 3.

54. An interface device which interfaces a media player devices, the interface device comprising:
a plurality of contact locations having sequentially designated numbers; and
a housing unit which comprises the plurality of contact locations,
wherein the plurality of contact locations comprise:
a first device pair contact location group which is configured to transmit data between a first pair of devices;
a second device pair contact location group which is configured to transmit data between a second pair of devices;
a third device pair contact location group which is configured to transmit data between a third pair of devices;
a fourth device pair contact location group which is configured to transmit data between a fourth pair of devices;
a fifth device pair contact location group which is configured to transmit data between a fifth pair of devices;
a sixth device pair contact location group which is configured to transmit data between a sixth pair of devices;
a seventh device pair contact location group which is configured to transmit data between a seventh pair of devices; and
an eighth device pair contact location group which is configured to transmit data between an eighth pair of devices.

55. The interface device as claimed in claim 54, wherein the first device pair contact location group comprises a first device pair plus contact location and a first device pair minus contact location for differential signaling.

56. The interface device as claimed in claim 54, wherein the housing unit is compatible with a High-Definition Multimedia Interface housing unit.

57. The interface device as claimed in claim 54, wherein the housing unit is a 19-pin housing unit.

58. The interface device as claimed in claim 54, wherein the plurality of contact locations further comprise a power transmission contact location which transmits power.

59. The interface device as claimed in claim 54, wherein at least one of the plurality of contact locations comprises a Consumer Electronics Controlcontact location.

60. The interface device as claimed in claim 54, wherein the housing unit is compatible with a High-Definition Multimedia Interface (HDMI) housing unit, and the first device pair contact location group corresponds to a Transition Minimized Differential Signaling contact location.

61. The interface device as claimed in claim 54, wherein:
the first device pair contact location group is designated as numbers 10 and 12;
the second device pair contact location group is designated as numbers 7 and 9;
the third device pair contact location group is designated as numbers 4 and 6;
the fourth device pair contact location group is designated as numbers 1 and 3;
the fifth device pair contact location group is designated as numbers 2 and 5;
the sixth device pair contact location group is designated as numbers 8 and 11;
the seventh device pair contact location group is designated as numbers 15 and 16; and
the eighth device pair contact location group is designated as numbers 14 and 19.

62. The interface device as claimed in claim 54, wherein the plurality of contact locations further comprise a contact location which is for ground processing and is designated as number 17,
wherein the eighth device pair contact location group uses the contact location, which is designated as the number 17, as a ground contact location.

63. The interface device as claimed in claim 54, wherein at least one of the plurality of device pair contact location groups is ground-processed via at least one of a ground contact location and a drain wire of another device pair contact location group.

64. The interface device as claimed in claim 54, wherein the housing unit is compatible with a High-Definition Multimedia Interface housing unit, and the eighth device pair contact location group corresponds to a Ethernet and Audio Return Channel contact location.

65. The interface device as claimed in claim 54, wherein the housing unit is compatible with a High-Definition Multimedia Interface housing unit, and the seventh device pair contact location group corresponds to a serial data contact location and a serial clock contact location.

66. The interface device as claimed in claim 54, wherein the interface device transmits and receives a wakeup signal, wherein the wakeup signal wakes up the external media player device from a standby mode.

67. The interface device as claimed in claim 66, wherein at least one of the plurality of contact locations comprises a Consumer Electronics Control (CEC) contact location,
wherein the CEC contact location transmits and receives the wakeup signal with the media player device.

68. The interface device as claimed in claim 66, wherein the wakeup signal comprises a start field which acknowledges a start of a wakeup command, a wakeup mode field which acknowledges a wakeup mode, and an Ack signal field.

69. The interface device as claimed in claim 68, wherein the mode of the wakeup comprises a plurality of wakeup modes, which respectively correspond to a plurality of operation modes of a media player device, and a charging mode.

70. The interface device as claimed in claim 66, wherein if the interface device receives a wakeup start command, the interface device determines an external media player device based on the wakeup start command.

71. The interface device as claimed in claim 70, wherein the wakeup start command comprises a start field which acknowledges a start of a wakeup command, a wakeup port filed which acknowledges a device to be woken up, a wakeup mode field which acknowledges a wakeup mode, and an Ack signal field.

72. The interface device as claimed in claim 54, wherein the interface device transmits and receives power with an external media player device via at least two contact locations of the plurality of contact locations.

73. The interface device as claimed in claim 72, wherein at least one of the at least two contact locations, which transmit and receive the power, is an audio/visual data transmission contact location.

74. The interface device as claimed in claim 54, wherein:
the first device pair contact location group is designated as numbers 1 and 3;
the second device pair contact location group is designated as numbers 2 and 4;
the third device pair contact location group is designated as numbers 5 and 7;
the fourth device pair contact location group is designated as numbers 6 and 8;
the fifth device pair contact location group is designated as numbers 9 and 11;
the sixth device pair contact location group is designated as numbers 10 and 12;
the seventh device pair contact location group is designated as numbers 13 and 15; and
the eighth device pair contact location group is designated as numbers 14 and 16.

75. The interface device as claimed in claim 54, wherein the plurality of contact locations further comprise:
a Consumer Electronics Control (CEC) contact location;
a ground contact location for ground processing; and
a power contact location which transmits power.

76. The interface device as claimed in claim 75, wherein:
the CEC contact location is designated as number 13;
the ground contact location is designated as number 17; and
the power contact location is designated as number 18.

77. The interface device as claimed in claim 74, wherein the plurality of contact locations further comprise:
a CEC contact location which is designated as number 19;
a ground contact location which is for ground processing and is designated as number 17; and
a power contact location which transmits power and is designated as number 18.
